(19) United States
(12) Patent Application Publication
(10) Pub. No.: US 2011/0209079 A1
(43) Pub. Date: Aug. 25, 2011

(54) GRAPHICAL DISPLAY WITH HIERARCHICAL GAUGE PLACEMENT

(75) Inventors: Christopher Tarte, Roanoke, TX (US); Wesley M. Mays, Coppell, TX (US)

(73) Assignee: PACCAR INC., Bellevue, WA (US)

(21) Appl. No.: 12/711,076

(22) Filed: Feb. 23, 2010

(51) Int. Cl. G06F 3/048

(52) U.S. Cl. 715/769; 715/854; 715/853

(57) ABSTRACT

A graphical display is provided to allow a user to dynamically customize the location, appearance, priority, and arrangement of virtual gauges displayed on an instrument panel of a vehicle. A user can select a virtual gauge and move to a desired location in the instrument panel. The selected virtual gauge is assigned a highest priority level, which may result in a hierarchical structure including other virtual gauges. In one aspect, the selected virtual gauge may appear more prominently that other virtual gauges in the hierarchical structure and thus is readily accessed by a user without having to navigate through multiple layers of other virtual gauges. When an adverse vehicle condition is identified, a virtual gauge associated with the condition is assigned an urgent priority level that generally trumps any priority levels assigned to other virtual gauges on the display.

### BACKGROUND

Interest in providing rich user experiences in operating a vehicle has grown in parallel with the proliferation and advancement in graphical displays. In this regard, in-vehicle graphical displays, such as graphical instrument panels, installed in interior surfaces of a vehicle convey information to a vehicle operator.

With the continued development of sophisticated vehicle systems, increasing amounts of information about vehicle conditions should be accessible to a vehicle operator. Depending on the driving conditions, some instruments of the graphical instrument panel are more important than others. However, typically, the graphical instrument panel can not be dynamically configured to display some instruments prominently over other instruments. Moreover, the conventional graphical instrument panel is not equipped with functional structures that allow a vehicle operator to conveniently configure the graphical instrument panel in response to the changes that a vehicle operator encounters while operating the vehicle.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

Aspects of the disclosed subject matter are directed to a graphical display that allows a user to customize the location, appearance, and arrangement of virtual gauges on an instrument panel. In accordance with an aspect of an embodiment, a computer implemented method is provided for customizing a priority of a graphical element that conveys vehicle readings in a display panel. The computer implemented method comprises receiving input from a user that changes a priority level associated with a first graphical element and obtaining a desired location of the first graphical element from the input from the user. If the desired location of the first graphical element generally corresponds to the location of a second graphical element, the first and second graphical elements are assigned different priority levels, which results in a hierarchical structure of the first and second graphical elements. The attributes of the first and second graphical elements are updated in accordance with the priority level assigned to each element. The display panel is rendered to reflect the changed attributes of the graphical elements in that a graphical element with a higher priority level appears more prominently than a graphical element with a lower priority level.

In accordance with another aspect of an embodiment, a display panel in that arrangement of graphical elements that conveys vehicle readings is provided for user configuration. The display panel is operative to detect a triggering event to change a priority of at least one graphical element and to determine if the triggering event is caused by an abnormal condition or by a user. If the triggering event is caused by the user, a first graphical element selected by the user inputs is assigned a first priority level. The display panel is further operative to obtain a desired location of the first graphical element from the user's input. In response to obtaining the desired location, a second graphical element of which priority is affected by the user input is identified and assigned a second priority level that has lower priority than the first priority level. The attributes of the first and second graphical elements are updated in accordance with the priority level assigned to each element and the desired location. If the triggering event is cause by the abnormal condition, a graphical element associated with the abnormal condition is assigned an emergency priority level that is the highest priority level among the priority levels assigned to the graphical elements displayed on the display. The display panel is further operative to obtain a location of the graphical element to be displayed on the display. The attributes of the graphical element associated with the abnormal condition are updated in accordance with the priority emergency level and the obtained location. The display panel is operative to render the graphical elements on the display panel to reflect the changes in the attributes of the graphical elements.

In accordance with yet another aspect of an embodiment, a graphical display having modules for changing a priority of a graphical element in the graphical display is provided where the graphical element is initially assigned a default priority level. The graphical display comprises a user interface module and a priority configuration module. The user module is configured to obtain input and render graphical elements on the graphical display. The priority configuration module is operative to allow a user to select a graphical element to assign a desired priority level that is higher than the default priority level, to reassign the selected graphical element with the desired priority level, and to obtain from the user a desired location for the graphical element in the graphical display. The priority configuration module is further operative to change attributes of the selected graphical element in accordance with the priority level assigned to the selected graphical element; and to cause the user interface module to render the selected graphical element on the graphical display in accordance with the changed attributes and the desired location. In an aspect, upon detection of an abnormal condition of a vehicle, the priority configuration module reassigns an emergency priority level to a graphical element associated with an abnormal condition, and the priority configuration module causes the graphical element associated with an abnormal condition to be rendered such that the user is alerted about the abnormal condition.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a pictorial depiction of an exemplary system architecture that illustrates components suitable for implementing aspects of the disclosed subject matter;

FIGS. 2A-2D are exemplary user interfaces depicting aspects of a graphical display in accordance with additional embodiments of the disclosed subject matter; and

FIG. 3 is a flow diagram of a routine for allowing a user to customize a priority of a graphical element displayed in the graphical display in accordance with additional embodiments of the disclosed subject matter.

### DETAILED DESCRIPTION

The detailed description set forth below in connection with the appended drawings where like numerals reference like elements is intended as a description of various embodiments of the disclosed subject matter and is not intended to represent the only embodiments. Each embodiment described in this disclosure is provided merely as an example or illustration and should not be construed as preferred or advantageous over other embodiments. The illustrative examples provided herein are not intended to be exhaustive or to limit the disclosure to the precise forms disclosed. Similarly, any steps described herein may be interchangeable with other steps, or combinations of steps, in order to achieve the same or substantially similar result.

Prior to discussing the details of the graphical display with hierarchical instrument placement, it should be understood that several sections of the following descriptions are presented largely in terms of logic and operations that may be performed by conventional components. These components, which may be grouped in a single location or distributed over a wide area, generally include processors, memory, storage devices, display panels, input devices, etc. In circumstances where the components are distributed, the components are accessible to each other via communication links. In the following description, numerous specific details are set forth in order to provide a description of the graphical display with hierarchical gauge placement. It will be apparent to one skilled in the art, however, that the disclosed subject matter may be practiced without some or all of the specific details.

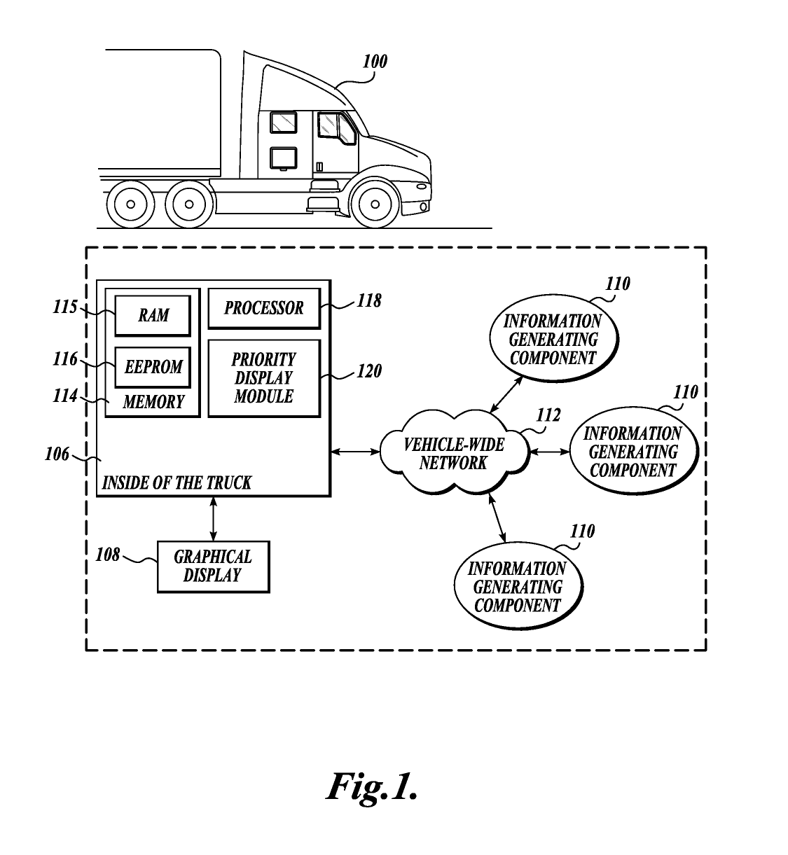

FIG. 1 and the following discussion is intended to provide a brief, general description of a system architecture in a truck 100 for implementing aspects of the disclosed subject matter. In the example depicted in FIG. 1, the truck 100 includes an electronic control unit 106 that is associated with a graphical display 108. As described in further detail below, the graphical display 108 is used to present information to a vehicle operator. In addition, the electronic control unit 106 is communicatively connected to a set of information generating components 110. One of ordinary skill in the art will appreciate that the system architecture of the truck 100 will include many more components than those depicted in FIG. 1. However, it is not necessary that all of these generally conventional components be shown or described. Moreover, while FIG. 1 depicts a truck 100, another type of “vehicle” such as a car, boat, Recreational Vehicle (“RV”), vessel, etc., may be used to implement aspects of the present disclosure.

As further illustrated in FIG. 1, the electronic control unit 106 may communicate with the information generating components 110 over a vehicle-wide network 112. Those skilled in the art and others will recognize that the vehicle-wide network 112 may be implemented using any number of different communication systems, such as the Society of Automotive Engineers' (SAE) J1939 standard. However, the disclosed subject matter may be implemented using other types of currently existing or yet-to-be-developed communication systems without departing from the scope of the claimed subject matter. For example, the information generating components 110 may be connected to the electronic control unit 106 using other electrical and/or mechanical communication systems.

In the illustrative embodiment depicted in FIG. 1, the truck 100 includes an electronic control unit 106. In one embodiment, the electronic control unit 106 serves as an in-vehicle computing device for managing the collection and dissemination of information. The electronic control unit 106 may collect information over the vehicle-wide network 112 from the information generating components 110. The collected information may be processed so that the appropriate readings may be presented on the graphical display 108.

In this regard and by way of example only, the information generating components 110 may report information about a number of vehicle systems, including but not limited to vehicle and engine speed, fluid levels, tire pressure monitoring, battery level, fluid level systems, transmission and engine temperatures, collision detection systems, hybrid drives, heating/cooling systems, among others. The graphical display 108 may be a liquid crystal display (LCD) or a light emitting polymer display (LPD) that may include a “touch screen” or sensitive layer configured to recognize direct input applied to the surface of the graphical display 108. For example, the position of the direct input, the pressure of the direct input, or general direction of the direct input may be recognized in order to obtain input from a vehicle operator. In other embodiments, the truck 100 includes conventional operator control inputs (not illustrated), for obtaining input from a vehicle operation that may include, but are not limited to, buttons, switches, knobs, etc.

In the illustrative embodiment depicted in FIG. 1, the electronic control unit 106 includes a memory 114 with a random access memory (“RAM”) 115 and an electronically erasable, programmable, read-only memory (“EEPROM”) 116, a processor 118, and a scrolling display module 120. Those skilled in the art and others will recognize that the EEPROM 116 may be a nonvolatile memory capable of storing data even through interruptions in the availability of power. Conversely, the RAM 115 may be a volatile form of memory that stores program instructions for direct access by the processor 118. Typically, a fetch-and-execute cycle in which instructions are sequentially “fetched” from the RAM 115 and executed by the processor 118 is performed. In this regard, the processor 118 is configured to operate in accordance with executable instructions that are available from the RAM 115.

As further illustrated in FIG. 1, the memory 114 includes a priority display module 120 that implements logic for efficiently presenting information on the graphical display 108. In particular, the priority display module 120 causes graphical elements that convey a variety of vehicle readings to be displayed in accordance with their assigned priority. To customize the layout of the instrumental panel, a user may be allowed to move one or more graphical elements to a desired location for a particular gauge layer. In this regard, multiple layers of gauges may be constructed by a user and assigned with a priority for display. When rendered, the multiple layers of gauges can be displayed in descending order of priority levels. Additional aspects of the priority display module 120 are described in further detail below.

As will be appreciated by those skilled in the art and others, FIG. 1 provides an example of one system architecture for implementing aspects of the present disclosure. In other embodiments, the functions and features of the truck 100 may be implemented using other components. For example, while FIG. 1 depicts an electronic control unit 106 that uses an EEPROM 116 for nonvolatile memory storage, those skilled in the art and others will recognize that other types of memory may be used. Thus, FIG. 1 depicts one component architecture for practicing the present disclosure, but other component architectures may be used without departing from the scope of the claimed subject matter.

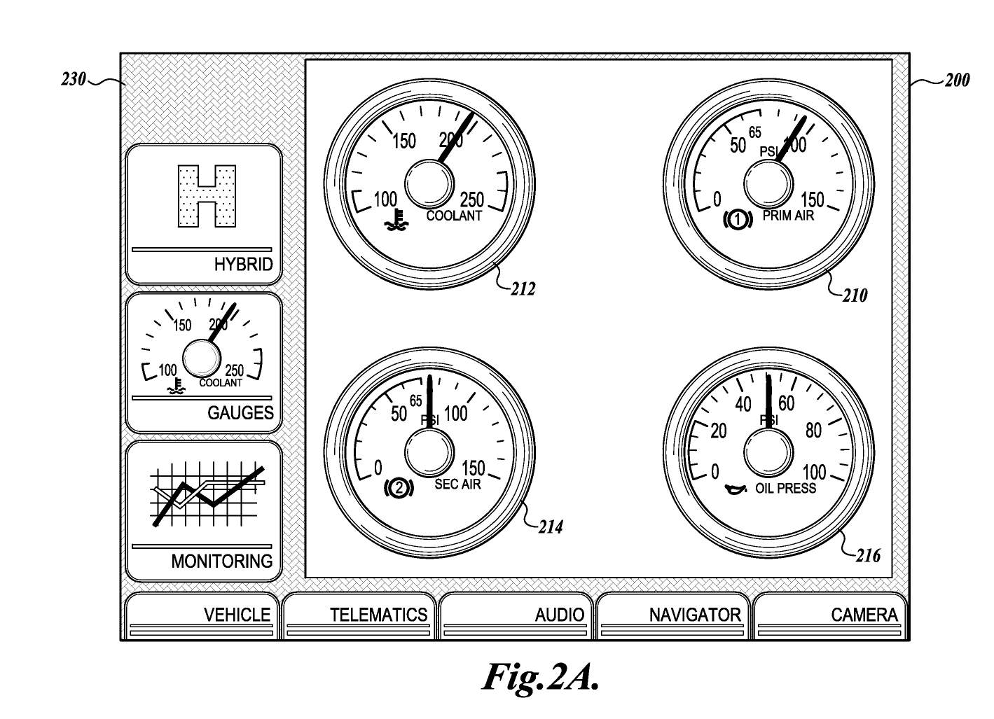

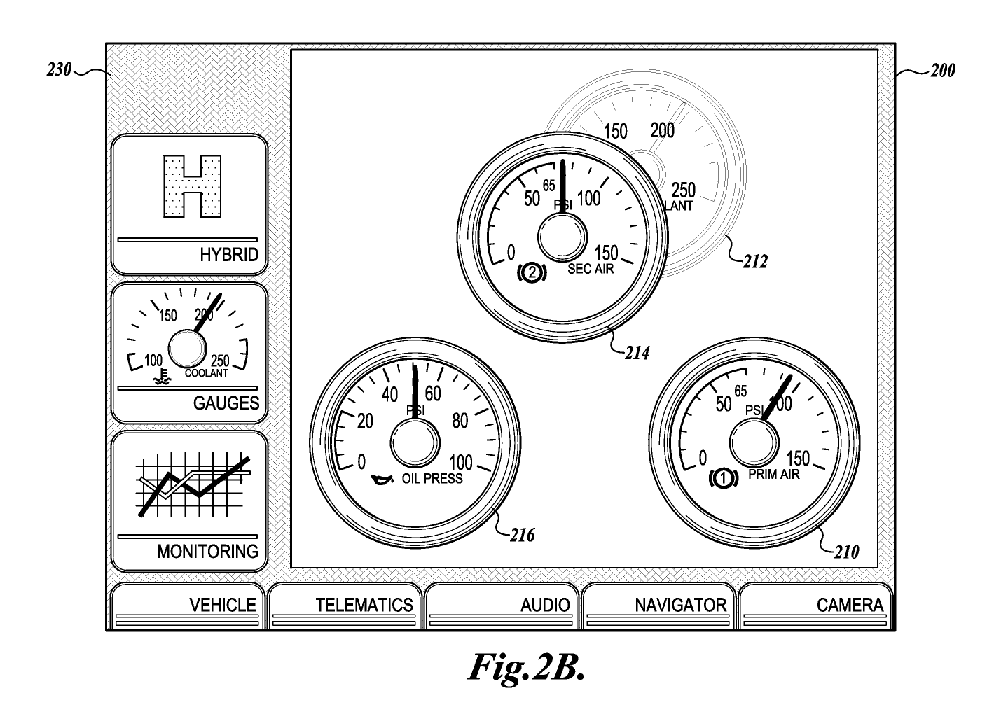

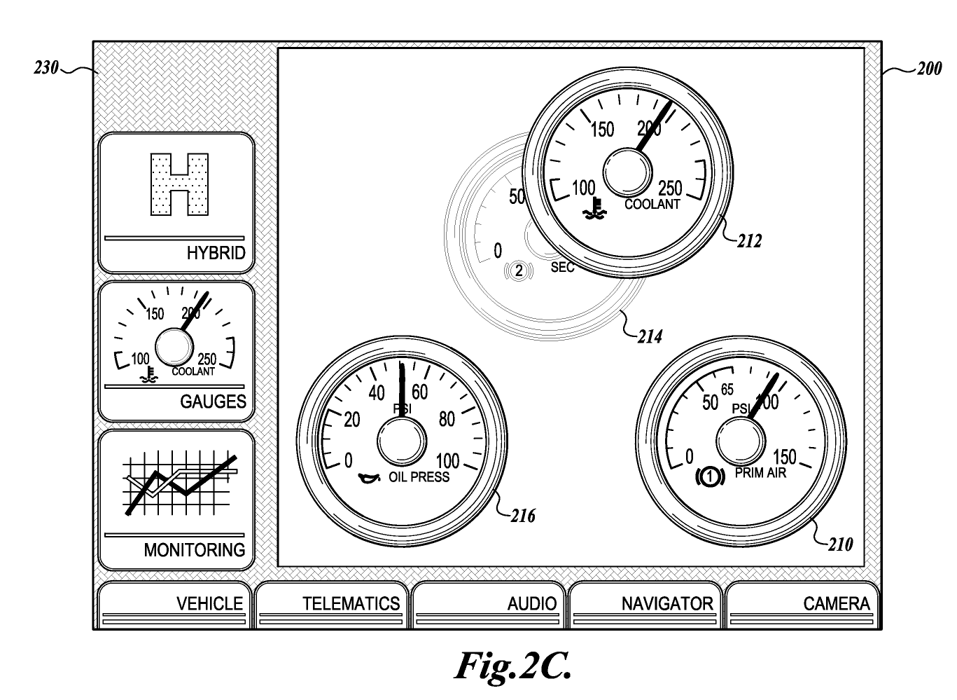

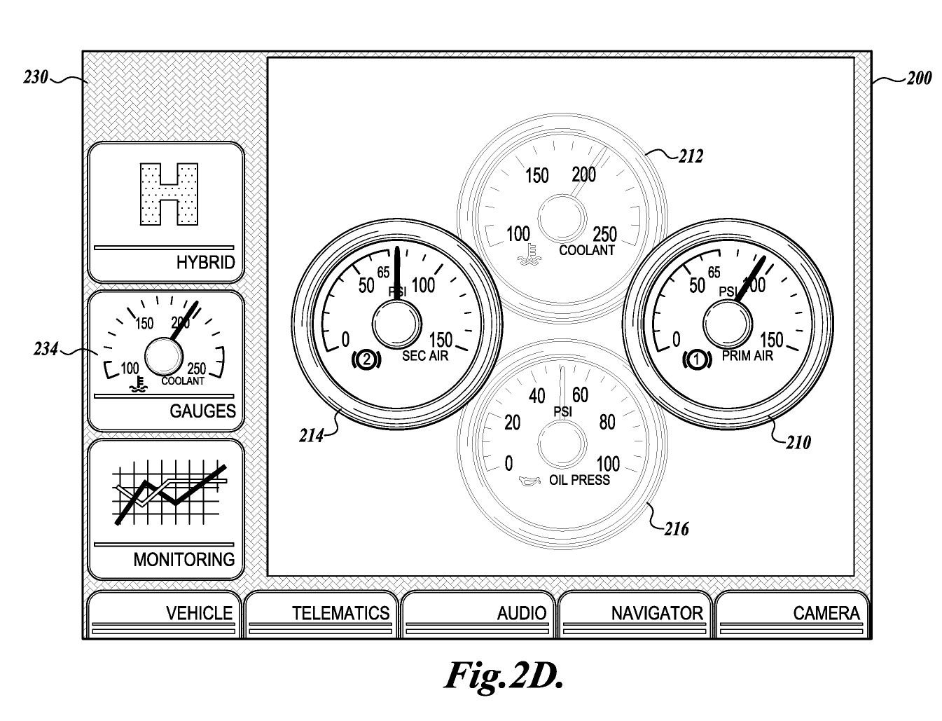

Now, with reference to FIGS. 2A-2D, “graphical elements” displayed in the graphical display 108 (FIG. 2) that may be used to illustrate aspects of the present disclosure will be described. These graphical elements may be comprised of various objects used to convey information including, but not limited to, text, icons, images, animations, and combinations thereof. While some of the graphical elements may be presented at fixed locations, other graphical elements can be customized and thus may be moved to different locations. In this regard, a user can arrange some graphical elements in a hierarchical structure, i.e., display layers in descending/ascending order of priorities, which will be described in further detail below. To arrange the graphical elements, a user may employ a “drag- and drop” technique in which a graphical element is selected by a stylus or user's finger, moved, and released at a desired location on the display for a particular layer in the hierarchical structure.

In the exemplary embodiment depicted in FIG. 2A, the graphical elements presented on the graphical display 108 represent various gauges including, but not limited to, a speedometer, tachometer, headlight indicator, oil pressure gauge, air pressure gauge (primary and secondary), fuel gauge, temperature gauge, voltmeter, turn signal indicator, cruise control indicator, fuel economy indicator, and a navigation indicator, among others. As known to those skilled in the art, the primary air pressure 210 and secondary air pressure 214 may present information to convey the air pressure level in an air brake system to a vehicle operator. For example, air pressure information may be collected by the electronic control unit 106 from an information generating component 110 associated with the air brake system. The collected data is processed so that the appropriate readings may be presented on both the primary air pressure 210 and secondary air pressure 214. In a similar way, data may be collected and processed in order to present readings for the other graphical elements presented on the graphical display 108.

In the exemplary embodiment depicted in FIG. 2A, the graphical display 108 includes several gauges in a default arrangement. In this embodiment, the coolant level gauge 212, oil pressure gauge 216, primary and secondary air pressure gauges 210, 214 are continually displayed on the graphical display 108. At default, each gauge has the same priority relative to each other. A user can select any of the graphical elements displayed in a graphical display 108 and move it to another location of the graphical display 108.

FIG. 2B includes the graphical display 108 that was described above with reference to FIG. 2A. Similar to the description provided above, the graphical display 108 depicted in FIG. 2B includes the coolant level gauge 212, oil pressure gauge 216, primary air pressure gauges 210 and secondary air pressure gauge 214. In this example, the user has selected and moved the secondary air pressure gauge 214 to a location where the secondary air pressure gauge 214 can be layered over the coolant level gauge 212. As a result, a hierarchical structure including the secondary air pressure gauge 214 and the coolant level gauge 212 is constructed, and the coolant level gauge 212 is assigned a priority level lower than the secondary air pressure gauge 214. When the priorities assigned to the graphical elements change, the graphical display 108 updates the screen to reflect the changes. For example, the coolant level gauge 212 is displayed less prominently than the other elements.

The priority levels assigned to those gauges in the hierarchical structure can be dynamically changed by a user or by an adverse vehicle condition. For example, when the user or vehicle operator wishes the reading of the coolant level gauge 212 to appear more prominently than the secondary air pressure gauge 214, the user selects the coolant level gauge 212 using a stylus or a finger. Subsequently, the priorities for these gauges 212 and 214 change so that the coolant level gauge 212 is displayed more prominently than the secondary air pressure gauge 214, readily accessible by the user while operating a vehicle, as depicted in FIG. 2C.

In addition, when an adverse vehicle condition is identified, for example, when the coolant level suddenly drops, the gauge associated with the condition (coolant gauge) is assigned a high priority level. If the gauge associated with an adverse vehicle condition is not currently shown to the user, the change in priority will result in the gauge associated with the adverse vehicle condition being displayed. In an aspect, such dynamic priority reassignment can provide an alert to the vehicle operator so that the vehicle operator can deal with the current adverse condition in a timely manner.

In some instances, it is desirable if all or most of the graphical elements are simultaneously presented to the user, thereby eliminating a need to navigate several menus to access some gauges. When the numbers of the gauges increase, the graphical elements representing the gauges cannot all be displayed at the same time within the limited display area. In such a case, a user can assign priorities to graphical elements in order to arrange the graphical elements in a hierarchical structure. By way of example only, a hierarchical structure may have two layers to provide a user or a vehicle operator with simple mechanics to manipulate graphical elements. In this example, the top layer in the hierarchical structure has a high priority level which includes a group of graphical elements for which the vehicle operator wants the readings to be convenient while operating the vehicle. A drag and drop technique may be used to assign a high priority level to the graphical elements. In general, upon being selected by a stylus or a finger, the graphical element is assigned a high priority level. The bottom layer in the hierarchical structure has a low priority level. The graphical elements included in the bottom layer will be assigned a low priority level. As will be appreciated, when only one graphical element is displayed and thus no graphical elements are layered, no hierarchical structure is needed. In that case, the graphical element is assigned a default priority level. With reference to FIG. 2D, all the graphical elements 210, 212, 214, 216 are placed into a central area, of which the primary air pressure gauge 210 and secondary air pressure gauge 214 are assigned a high priority level.

In an alternative embodiment, a hierarchical structure with three or more layers (not shown) may be constructed with different visual attributes. For example, when displayed, three or four gauges can be layered in order of priority levels assigned to the gauges. In this example, the first layer includes elements with the highest priority level that need to be displayed more prominently than other layers. The second layer includes elements with the next highest priority level that can be displayed less prominently than the first layer, but are still quite visible. The third layer includes elements with the next highest priority level that can be displayed much less prominently, but visible enough so that the user can select them to change their priority levels, and so on with the remain levels.

Although it is not shown, there are graphical elements (off-screen elements) that are available for display but not currently displayed on the screen. Upon the user's indication to add new graphical elements, those graphical elements may be displayed in a menu space of the graphical display or in a populated additional screen from which the user can drag and drop any off-screen elements to the graphical display. Now with reference back to FIG. 2D, the user can select the “GAUGES” button 234 from the menu space 230 to open a display of all the “off-screen” elements (not shown) representing various gauges that are not currently represented in the graphical display.

In addition or alternatively, a vehicle operator may configure the degree of prominence of each layer when setting up an initial system, i.e., at the time of start-up of the vehicle engine. The degree of prominence can be configured by a level of LCD brightness, thickness or shape of lines that form a graphical element, color of the graphical elements, or the like. By way of example only, a degree of a color contrast may be used to configure the degree of prominence of layers. If the background is “black”, “white” may be more prominent than “light gray,” which is in turn more prominent than “dark gray”. As such, white is used to display the graphical elements included in the first layer, light gray used to display the graphical elements included in the second, the dark gray to display the third, and so on. In another example, a solid line may be more prominent than a dotted line and a thicker line may be more prominent, and so on.

In some embodiments, a graphical element that conveys information about an abnormal vehicle condition may be temporally assigned an emergency priority so that the graphical element is displayed in such a way as to attract the attention of the vehicle operator. Once the abnormal vehicle condition is resolved, the graphical element will revert to the previously assigned priority, and thus disappear from the display if the graphical element was an off-screen element. In one embodiment, the vehicle operator may be prompted to confirm whether or not to remove the graphical elements from the display. In one embodiment, an emergency layer may trump all other layers having various levels of priority. The graphical element associated with the abnormal vehicle condition may be displayed with increased size, in a color indicative of an abnormal or warning condition (e.g., yellow, red, etc.) and/or flashing in one or more colors, etc.

While specific configurations of the graphical display 108 have been described above with reference to FIGS. 2A-2D, those skilled in the art and others will recognize that the features of the disclosed subject matter may be configured in other ways. For example, a default screen that includes graphical elements to convey information about specific vehicle conditions is described with reference to FIGS. 2A-2D. However, aspects of the disclosed subject matter may be used to convey information about other types of vehicle conditions. Accordingly, the examples provided above with reference to FIGS. 2A-2D should be construed as exemplary.

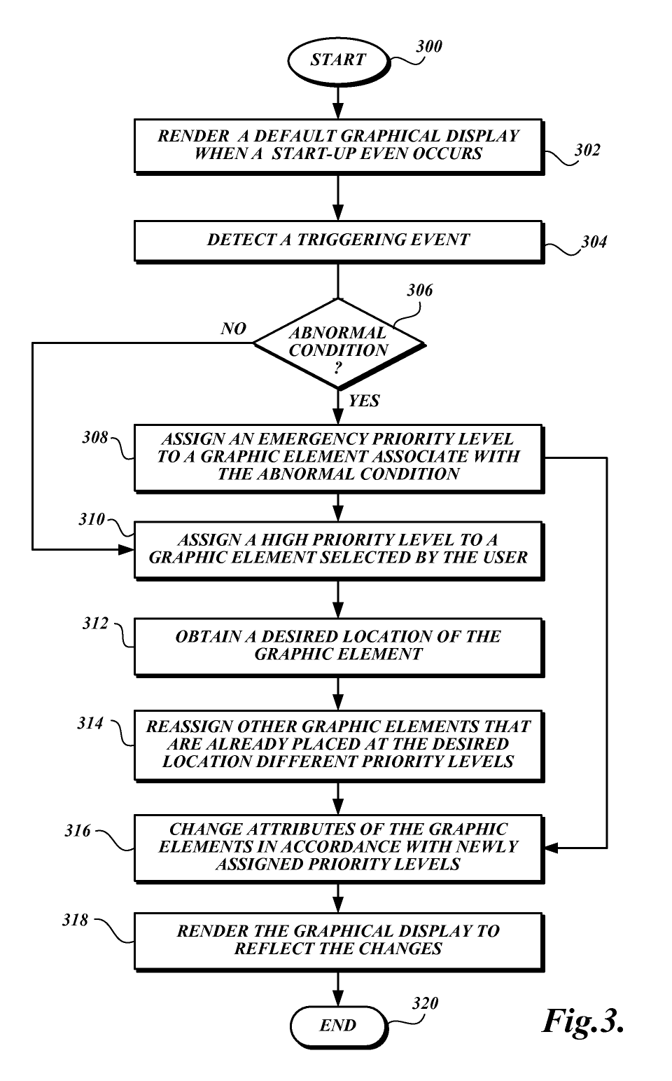

Now with reference to FIG. 3, a flow diagram will be described that depicts one exemplary embodiment of a routine 300 for allowing a vehicle operator to assign priorities to graphical elements in accordance with the disclosed subject matter. In one embodiment, the routine 300 may be implemented by the priority display module 120 in the electronic control unit 106 (FIG. 1). Accordingly, data may be collected from a plurality of information generating components 110 so that the appropriate readings may be presented on the graphical display 108, as described above.

As illustrated in FIG. 3, the routine 300 begins at block 302 where a start-up event occurs that will cause graphics to be rendered on the graphical display 108. Generally described, a start-up event is an event type that will cause the graphical display 108 to transition from an inactive state to an active state. By way of example only, the start-up event that occurs at block 304 may be the ignition of the vehicle's engine, which results in power being supplied to an ignition bus. Also, the graphical display 108 may be put to “sleep” in a reduced power state when the vehicle is inactive for a predetermined period of time. Thus, the start-up event may be another type of event, such as the return of the graphical display 108 from a reduced power state.

The display method 300 renders a set of default graphical elements on the graphical display 108, at block 302. The graphical elements that are rendered may be defined in default settings and be similar to the graphical elements depicted in FIGS. 2A-2D. In conjunction with rendering the default graphical elements, the electronic control unit 106 begins collecting data from the information generating components 110. This data may be continually collected and processed so that current readings may be conveyed on the graphical display 108. As described in further detail below, each graphical element that may be rendered on the graphical display 108 is assigned a default priority level that can dynamically change based on the user's configurations. When readings are within normal operating parameters, a corresponding graphical element may be assigned a default priority level. As discussed above, a graphical element may be reassigned an enhanced priority level if the user rearranges the layout of the default screen or an abnormal condition is detected. This aspect of the present disclosure is described in further detail below.

As further illustrated in FIG. 3, at block 304 of the routine 300, a triggering event is detected that will start a configuration of priority levels among graphical elements. As described above with reference to FIGS. 2A-2D, a number of different triggering events may be defined. The user can select and move one or more graphical elements using a stylus or a finger to a desired location. Simply put, the most recently selected graphical elements will be assigned a higher priority level compared to other elements. Generally described, each graphical element will have a default priority level assigned unless the user's interaction causes at least two graphical elements to be layered with respect to each other. In such case, the selected graphical element that is moved and placed on top of another graphical element will be assigned the higher priority over the graphical element that has been previously placed at the desired location. As a result, other graphical elements that are not affected by the user interactions will have an unchanged priority level. In this manner, only those graphical elements that the user clearly indicates to rearrange will be assigned different priorities.

However, other types of triggering events may change the arrangement and priorities of the graphical elements. For example, a triggering event is also generated when an abnormal vehicle condition is detected so that a corresponding graphical element may be displayed most prominently.

At decision block 306, a test is performed to determine whether the triggering event, detected at block 304, relates to an abnormal vehicle condition. To determine whether an abnormal vehicle condition exists, data collected by the electronic control unit 106 may be compared to a set of data that define normal operating parameters. For example, a vehicle manufacturer may establish normal operating parameters for various components and systems. These parameters may be compared to actual readings being reported by the information generating components 110. In instances when an actual reading is outside a normal range, the result of the test performed at block 306 is “Yes.” In this instance, when an abnormal vehicle condition is the triggering event, the display method 300 proceeds to block 316, described in further detail below. In contrast, if the triggering event relates to the user configuration then the result of the test performed at block 310 is “No.” In this instance, the display method 300 proceeds to block 310.

At block 310, a graphical element selected by the user is assigned a highest priority level. At block 312, the desired location to place the selected graphical element is obtained. Generally, the user's interaction with the GUI provides such information. For example, when using the Drag and Drop technique, the location where the user drops the graphical element is provided. If the user simply selects the graphical element, the current location of the element will be obtained. At block 314, the routine identifies other graphical elements of which priority may change due to the movement of the selected graphical element and reassigns the identified graphical elements the appropriate priority levels. In that regard, if the movement results in a hierarchical structure of gauges to be displayed, the identified gauges are reassigned different priority levels which are lower than the priority level assigned to the selected graphical element.

At block 316, attributes of the graphical elements are changed in accordance with the newly assigned priorities. At block 318, the updated display is rendered to reflect the changes made to the graphical elements.

As mentioned above, when the result of the test performed at block 306 is “Yes,” the routine proceeds to block 308 where a graphical element associated with the abnormal vehicle condition is assigned an emergency priority level. In addition or alternatively, several emergency priority levels can be assigned, depending on which vehicle component or system experiences the abnormal vehicle condition. The emergency priority level assigned may depend on the extent in which a reading diverges from normal parameters. For example, the detection of a transmission temperature that diverges substantially from a normal reading may be assigned an emergency priority level that is indicative of a critical condition. A tire pressure reading that diverges from normal parameters with a small scale may be assigned an emergency priority level that is lower than a high transmission temperature. Moreover, a manufacturer, vehicle operator, and/or user may define which emergency priority levels will be assigned to various abnormal vehicle conditions. In any event, upon detection of an abnormal vehicle condition, a graphical element associated with the abnormal condition is assigned an emergency priority level at block 308. As discussed above, the emergency level generally trumps any priority levels assigned to other graphical elements on the display.

At block 316, the attributes of the graphical element are updated in accordance with the emergency priority. The graphical element has attributes for conveying information about an abnormal vehicle condition. In the example described above with reference to FIGS. 2A-2D, logic for implementing the routine 300 updates the attributes of a graphical element which was previously allocated an “off-screen” location, to be displayed most prominently over other graphical elements. In other instances, the display may include a designated space for the emergency priority level elements. The logic for implementing the routine 300 at block 316 involves changing the arrangement of all the graphical elements that are currently displayed. At block 318, the updated graphical display is rendered to reflect the changes made to the graphical elements. After block 318, the routine 300 completes at block 320

It should be well understood that the routine 300 described above with reference to FIG. 3 does not show all of the functions performed when rendering the graphical elements on a graphical display. Instead, the routine 300 describes exemplary embodiments of the disclosed subject matter. Those skilled in the art and others will recognize that some functions may be performed in a different order, omitted/added, or otherwise varied without departing from the scope of the claimed subject matter.

While illustrative embodiments have been illustrated and described, it will be appreciated that various changes can be made therein without departing from the spirit and scope of the disclosed subject matter.

The embodiments of the invention in which an exclusive property or privilege is claimed are defined as follows:

1. A computer implemented method for customizing a priority of a graphical element that conveys vehicle readings in a display panel, wherein the graphical element is initially assigned a default priority, the computer implemented method comprising:
receiving input from a user that changes a priority level associated with a first graphical element;
obtaining a desired location of the first graphical element from the input from the user;
if the desired location of the first graphical element generally corresponds to the location of a second graphical element, then:
reassigning the first and second graphical elements different priority levels, which results in a hierarchical structure of the first and second graphical elements;
changing attributes of the first and second graphical elements in accordance with the priority level assigned to each element;
rendering the display panel to reflect the changed attributes of the graphical elements, wherein a graphical element with a higher priority level appears more prominently than a graphical element with a lower priority level.

2. The computer implemented method of claim 1, wherein if the desired location of the first graphical element generally corresponds to more than one second graphical elements, the order in the priority levels assigned to the second graphical elements is determined.

3. The computer implemented method of claim 2, wherein the priority levels of the second graphical elements are reassigned so that the priority levels of the second graphical elements are lower than the priority level of the first graphical element, while maintaining the determined order in the priority levels.

4. The method of claim 1, wherein the user uses a drag and drop technique to change the priority level associated with the first graphical element.

5. The method of claim 4, wherein the user uses a stylus or a finger for the drag and drop technique.

6. The method of claim 1, wherein the display panel includes multiple display layers, each of which is associated with a priority level and includes at least one graphical element of the same priority level associated with the layer.

7. The method of claim 6, wherein the display panel includes a plurality of display layers that are assigned different priority levels.

8. The method of claim 7, wherein each display layer includes at least one graphical element with the same priority level assigned to the display layer.

9. The method of claim 8, wherein the plurality of display layers are rendered in descending order of the priority level.

10. The method of claim 7, further comprising allowing the user to navigate between the plurality of display layers.

11. The method of claim 1, wherein the changed attributes includes at least one attribute from a group consists of a color attribute, brightness attribute, line attribute and size attribute.

12. A display panel in which arrangement of graphical elements that convey vehicle readings may be configured by a user, the display panel operative to:
detect a triggering event to change a priority of at least one graphical element;
determine if the triggering event is caused by an abnormal condition or by a user;
if the triggering event is caused by the user:
assign a first graphical element a first priority level, wherein the user inputs to select the first graphical element;
obtain a desired location of the first graphical element from the user's input;
in response to obtaining the desired location, identify a second graphical element of which priority is affected by the user input, wherein the second graphical element is assigned a second priority level that has lower priority than the first priority level;
change attributes of the first and second graphical elements in accordance with the priority level assigned to each element and the desired location;
if the triggering event is cause by the abnormal condition:
assign a graphical element associated with the abnormal condition an emergency priority level, wherein the emergency priority level is the highest priority level among the priority levels assigned to the graphical elements displayed on the display;
obtain a location of the graphical element to be displayed on the display;
change attributes of the graphical element associated with the abnormal condition in accordance with the priority emergency level and the obtained location; and
render the graphical elements on the display panel to reflect the changes in the attributes of the graphical elements, wherein the graphical element with higher priority appears more prominently than the graphical element with lower priority.

13. The display panel of claim 12, wherein the display panel includes a plurality of display layers that are assigned different priority levels and wherein each display layer includes at least one graphical element with the same priority level assigned to the display layer.

14. The display panel of claim 13, wherein the plurality of display layers are rendered in descending order of the priority level.

15. The display panel of claim 14, further comprising allowing the user to navigate between the plurality of display layers.

16. A graphical display having modules for changing a priority of a graphical element in the graphical display, wherein the graphical element is initially assigned a default priority level, the graphical display comprising:
a user interface module configured to obtain input and render graphical elements on the graphical display;
a priority configuration module operative to:
allow a user to select a graphical element to assign a desired priority level that is higher than the default priority level;
reassign the selected graphical element with the desired priority level;
obtain from the user a desired location for the graphical element in the graphical display;
change attributes of the selected graphical element in accordance with the priority level assigned to the selected graphical element; and
cause the user interface module to render the selected graphical element on the graphical display in accordance with the changed attributes and the desired location,
wherein upon detection of an abnormal condition of a vehicle, the priority configuration module reassigns an emergency priority level to a graphical element associated with an abnormal condition, and the priority configuration module causes the graphical element associated with an abnormal condition to be rendered such that the user is alerted about the abnormal condition.

17. The graphical display of claim 16, wherein the graphical element associated with an abnormal condition is rendered on a central location on the graphical display, designated for alerting the user.

18. The graphical display of claim 16, wherein before changing attributes of the selected graphical element, one or more graphical elements of which locations generally correspond to the desired location of the selected graphical element are assigned different priority levels, which results in a hierarchical structure of the graphical elements.

19. The display panel of claim 18, wherein the graphical elements in the hierarchical structure are rendered in descending order of the priority level.

20. The display panel of claim 19, wherein when rendered, the graphical element with a higher priority level appears more prominently than the graphical element with a lower priority level.
